(19) United States
(12) Patent Application Publication
(10) Pub. No.: US 2003/0055680 A1
(43) Pub. Date: Mar. 20, 2003

(54) Financial analysis of healthcare service agreements

(76) Inventor: Cherise A. Skeba, Fremont, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/189,891

(22) Filed: Jul. 3, 2002

Related U.S. Application Data
(60) Provisional application No. 60/304,923, filed on Jul. 11, 2001.

(51) Int. Cl. G06F 17/60

(52) U.S. Cl. 705/2

(57) ABSTRACT

Rate schedules specify payment mechanisms and rates based upon which healthcare service providers are compensated for services by insurers. The invention provides a tool for predicting the total compensation under a rate schedule based upon expected levels of service utilization for a provider during a time period. Service utilization levels characteristic of the provider are supplied for a relatively small number of general classes of medical services. Aggregate utilization data that is collected from multiple service providers by government authorities provides a reliable distribution of data that is based upon a large population and that is specifically categorized using hundreds of DRG codes. The specifically categorized aggregate utilization data is scaled based upon the general utilization levels of the provider to create a predicted set of service utilization data. The rate schedule is applied to the predicted set of service utilization data to determine total compensation.

### RELATED APPLICATIONS

This application claims the benefit of U.S. Provisional Application No. 60/304,923, filed on Jul. 11, 2001, which is hereby incorporated by reference.

### BACKGROUND OF THE INVENTION

1. Field of the Invention

The present invention relates generally to the healthcare industry, and more particularly the invention relates to techniques for predicting financial outcomes of healthcare services agreements under which payers, such as insurers, pay service providers, such as hospitals, for services rendered to patients.

2. Description of the Related Art

Healthcare providers (hereinafter “providers”) are professionals, individuals, or organizations that provide healthcare services. Providers may be, for example, hospitals, doctors, professional organizations (such as groups of doctors or medical groups), clinics, nursing homes, or skilled nursing facilities (SNF). Payers (alternatively “insurers”) are organizations, such as insurers, that cover the costs of healthcare for covered individuals (alternatively “insureds”) and typically arrange for healthcare to be provided to the insureds.

Providers and payers generally enter into healthcare services agreements or contracts under which the terms of services to be provided and the payment for the services to be provided are agreed upon in advance of the services being provided. Providers and payers generally enter these contracts to establish a relationship under which numerous services can be provided to numerous insureds. Payers can negotiate discounts for services from providers in exchange for agreements to direct insureds to a particular provider or a group of providers.

A healthcare services agreement typically includes a rate schedule, which is a schedule or listing of rates at which the payer will pay the provider for services rendered. Rate schedules may be simple or extremely complex. For example, a simple rate schedule may specify that the payer will pay for all services at billed rates reduced by a fixed discount. Billed rates are the rates at which providers bill for their services.

A more complex rate schedule, for example, may specify specific per day or per case rates at which some or all services will be paid. One system for associating services with payments is Diagnostic Related Groupings (DRG). In using DRGs, services are paid for based upon diagnoses rather than actual effort involved in resolving the diagnoses. Possible diagnoses are categorized into DRGs and assigned DRG codes. Each DRG code is presumed to merit a certain number of DRG units, where each unit represents a unit of care/services. By fixing a DRG unit rate at which each DRG unit is paid, the rate at which any DRG associated diagnosis is to be paid can be determined. Accordingly, a rate schedule may specify a DRG base unit rate at which specified DRGs are paid. The DRG rate may be used in addition to other rates, for example, to override more generally specified rates, in the case a specified DRG applies.

Another rate schedule may specify, in addition to specific per day or per case rates, that the amount paid will be the lesser of a discounted billed rate or a per day/per case rate. Rate schedules can also include “stop loss” provisions wherein certain services are billed at different rates when certain thresholds are reached. For example, a stop loss provision may specify that if a patient's stay at a hospital exceeds a specified duration, the rate for the whole stay is paid at a further discounted rate.

Rate schedules can specify different rates for various categories of service, such as, for example: general intensive care, critical care, pediatric intensive care, cardiac, maternity, transplant, surgery, and general medicine, among others.

Once a rate schedule is agreed upon, services are provided by the provider(s) and paid for by the payer for the duration of the agreement. Over the duration of the agreement, the payer will pay the provider(s) an aggregate total payment for all services rendered under the agreement.

In order to be in the best position to negotiate a rate schedule, it would be advantageous to each of the payer and the provider, to be able to predict a financial outcome based upon a proposed rate schedule. It would also be advantageous to be able to determine the effects of changes to a rate schedule on the financial outcome/aggregate payments under the rate schedule. The present invention seeks to provide these capabilities among others.

### SUMMARY OF THE INVENTION

The present invention provides a system and associated methods for predicting a financial outcome under the terms of a rate schedule of a provider-payer healthcare services agreement. The financial outcome preferably represents the aggregate sum of amounts that would be paid for services during the pendency of the agreement.

Inputs to the system preferably include a rate schedule, a set of generally classified historical provider service utilization data based upon past experience of the service provider, and a set of specifically categorized service utilization data (also referred to as “aggregate data”) that is relevant to the service provider. The provider service utilization data preferably includes service utilization data for each of a number of general classes of service during a sample time period. The aggregate data includes service utilization data that is categorized at a much finer level of detail than the provider service utilization data. The aggregate data is preferably derived by querying a large database of actual encounter data for records that match the particular characteristics of the service provider.

The aggregate data and the provider service utilization data are used to create a set of predictive service utilization data. The aggregate service utilization data is preferably scaled and/or adjusted based upon utilization levels in the provider service utilization data in order to obtain the predictive service utilization data. The predictive service utilization data is preferably also adjusted to take into account expected rates of inflation or change in healthcare costs and/or utilization levels. The predictive service utilization data is preferably maintained in the same format and is categorized using the same specific categories as the aggregate service utilization data.

The terms of the rate schedule are applied to the predictive service utilization data to determine a financial outcome. The rate schedule is preferably translated into, provided in, and/or maintained in a standardized format, including a rate structure (a set of rates) for each of a number of standardized rate categories. Service data from each specific category in the predictive service utilization data is associated with one or more of the standardized rate categories. The rate structure from the associated rate category is applied to the service utilization data from each specific category in the predictive service utilization data to determine a paid amount for the specific category. The amounts paid for all the specific categories are summed to obtain the predicted financial outcome or the total amount paid.

The system preferably allows a user to adjust terms of the rate schedule and/or the utilization levels in the provider service utilization data to determine the resulting effect on the financial outcome. The system can preferably also be configured to output the change or difference in the financial outcome that would result from a user-specified change to the rate schedule and/or the provider utilization levels.

These and other aspects of the invention will be described in additional detail in the Detailed Description below, which is organized as follows:

I. Overview

A. General Data Flow and Method

B. Input Data

C. Creating Predictive Service Utilization Data

D. Determining a Financial Outcome

II. Input Data

A. The Rate Schedule

B. Creation of Specifically Categorized Aggregate Service Utilization Data

C. Composition of Specifically Categorized Aggregate Service Utilization Data

D. Generally Classified Historical Provider Service Utilization Data

III. Creating Predictive Service Utilization Data

A. Creating the Adjusted Generally Classified Services Utilization Data

B. Applying the Adjusted Utilization Data to the Aggregate Data

IV. Determining a Financial Outcome

V. Conclusion

### BRIEF DESCRIPTION OF THE DRAWINGS

FIG. 1 illustrates a high-level data flow diagram in accordance with an illustrative embodiment.

FIG. 2 illustrates, at a high level, a general method in accordance with the illustrative embodiment.

FIG. 3 illustrates sources from which the specifically categorized aggregate service utilization data can be derived in accordance with the illustrative embodiment.

FIG. 4 illustrates a method for creating specifically categorized aggregate service utilization data.

FIG. 5 is a high-level diagram of the creation of the predictive service utilization data in accordance with the illustrative embodiment.

FIG. 6 illustrates a method in accordance with which provider service utilization data can be adjusted, using a confidence factor, to reflect an alternative distribution of services.

FIG. 7 illustrates a data flow in accordance with the method of FIG. 6.

FIG. 8 illustrates a method in accordance with the illustrative embodiment for applying adjusted utilization data and generally classified aggregate service utilization data to the aggregate data to create predictive service utilization data.

FIG. 9 illustrates pseudocode routine configured to perform a compensation of range-based variables.

FIG. 10 illustrates a method in accordance with the illustrative embodiment for processing each specific category of data to determine a total amount paid under the subject rate plan.

### DETAILED DESCRIPTION OF THE INVENTION

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent components and methods to those described herein. In other instances, well-known components and methods have not been described in detail so as not to unnecessarily obscure aspects of the present invention.

I. Overview

The present invention provides a tool or system and associated methods for predicting financial outcomes under the terms of rate schedules of provider-payer healthcare services agreements. An illustrative embodiment that is directed to analyzing rate schedules covering hospital inpatient services will be presented herein. The techniques illustrated with respect to this embodiment, however, can be extended to apply to other rate schedules covering, for example, outpatient services, clinic services, or any other type of medical service or product for which rate schedules can be used to specify payment rates.

The present invention can be embodied in any of several different forms depending upon the configuration in which it is to be used. The invention can be embodied in a software program or package that can be executed by a provider or a payer. Alternatively, the invention can be incorporated in a software application that is hosted by a third party (known as an Application Service Provider or ASP). The Application Service Provider can provide access to the application through a web site, for example, which can be accessed by payers and providers. The invention can also be embodied as a programmed computer system that can be maintained by a payer, a provider, or a third party that provides access to the system to payers and/or providers.

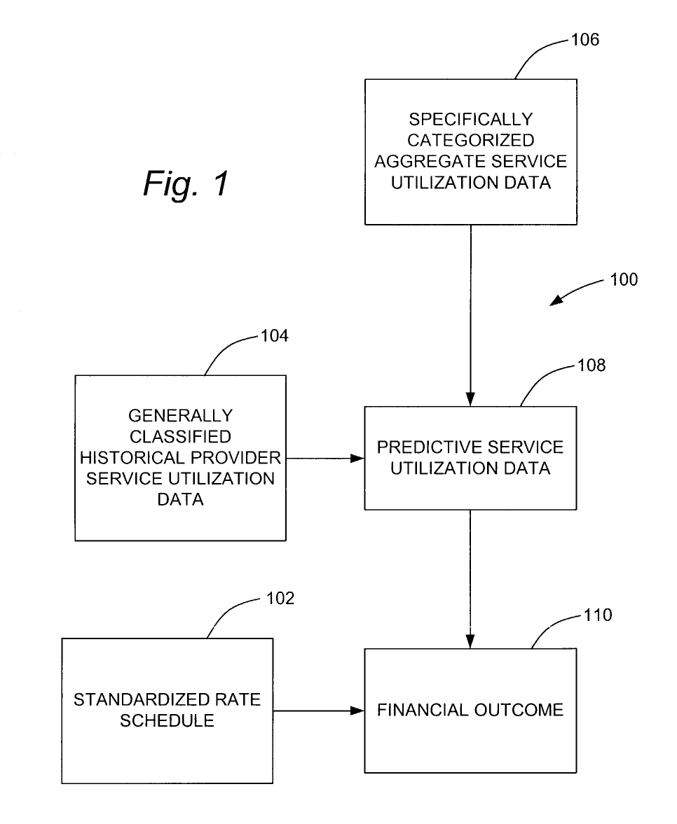

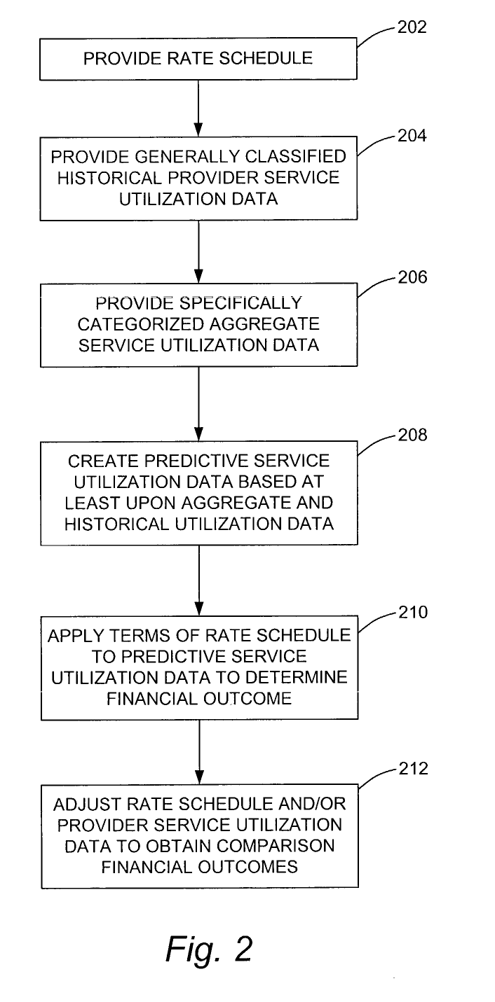

A. General Data Flow and Method FIG. 1 illustrates a data flow diagram 100 that depicts, at a high level, supplied input data, intermediate data, and output results in accordance with the illustrative embodiment. FIG. 2 illustrates, at a high level, a general method 200 in accordance with the illustrative embodiment. The illustrative embodiment is configured to provide a financial outcome, which is preferably an aggregate sum of amounts paid for services during the pendency of an agreement.

In accordance with the illustrative embodiment, an analysis is preferably performed with respect to a subject rate plan, a subject services provider, and a subject time period. As used herein, the subject rate plan is the rate plan for which the outcome is to be predicted or analyzed. The subject provider is preferably a hospital or an associated group of hospitals by which services are to be provided under the subject rate plan. In alternative embodiments, the subject provider can be any service provider or group of service providers by which services are to be provided under a subject rate plan. The subject time period is the time period over which the financial outcome is to be predicted.

B. Input Data

Referring to FIG. 1, the system inputs preferably include: a rate schedule 102, a set of generally classified historical provider service utilization data 104 based upon past experience of the subject service provider, and a set of specifically categorized service utilization data 106 that is relevant to the subject service provider.

Referring to FIG. 2, at a step 202 the rate schedule 102 is provided. The rate schedule 102 is preferably translated in or entered into the system and stored in a standardized format. Alternatively, the rate schedule can be supplied by the user in a standardized format. An example format will be presented in Subsection II.A below, but other formats can be used.

At a step 204, generally classified historical provider service utilization data 104 is provided. The generally classified historical provider service utilization data 104 preferably includes service utilization data for each of a number of classes of service during a sample time period. The classes of service may include, for example, cardiac services, maternity services, and behavioral health services. The classes of service are preferably specified at a level of detail that allows the user (payer or provider) to easily collect and/or supply the data. For each class of service, the provider service utilization data 104 preferably include total amounts billed for all services, as well as numbers of encounters or services performed based upon past experience of the subject service provider over a time period. An example format for the provider service utilization data 104 will be presented in Subsection II.D below, but other formats can be used.

As used in practice, a billed amount includes charges billed by a provider and is typically based on the provider's standard billing rates. Billed charges oftentimes include non-covered services (e.g., medically unnecessary services), errors (e.g., duplicate bills), and any other amounts not approved for payment under an agreement. Accordingly, billed amounts are preferably adjusted to correct for these non-covered services, errors or other non-approved amounts. Billed amounts that have been corrected or adjusted are typically referred to as covered amounts. For the sake of simplifying the present description, the term “billed” will be used to refer to corrected billed amounts and covered amounts rather than actual billed amounts that may include non-covered charges.

At step 206, the specifically categorized service utilization data 106 is created or provided. The specifically categorized service utilization data 106 (also referred to as “aggregate service utilization data”) includes service utilization data that is categorized at a much finer level of detail than the provider service utilization data 104. In the illustrative embodiment, the aggregate service utilization data 106 is categorized into specific categories. In the illustrative embodiment, the data is categorized primarily by DRG codes, of which there are more than 500, thus enabling a very fine level of detail. For each specific category, several items of data are specified, such as, for example: the DRG code, a DRG weight assigned by the Health Care Financing Administration, aggregate billed charges, aggregate covered charges, and aggregate paid charges, numbers of admissions allocated to the DRG, and various other data associated with the DRG.

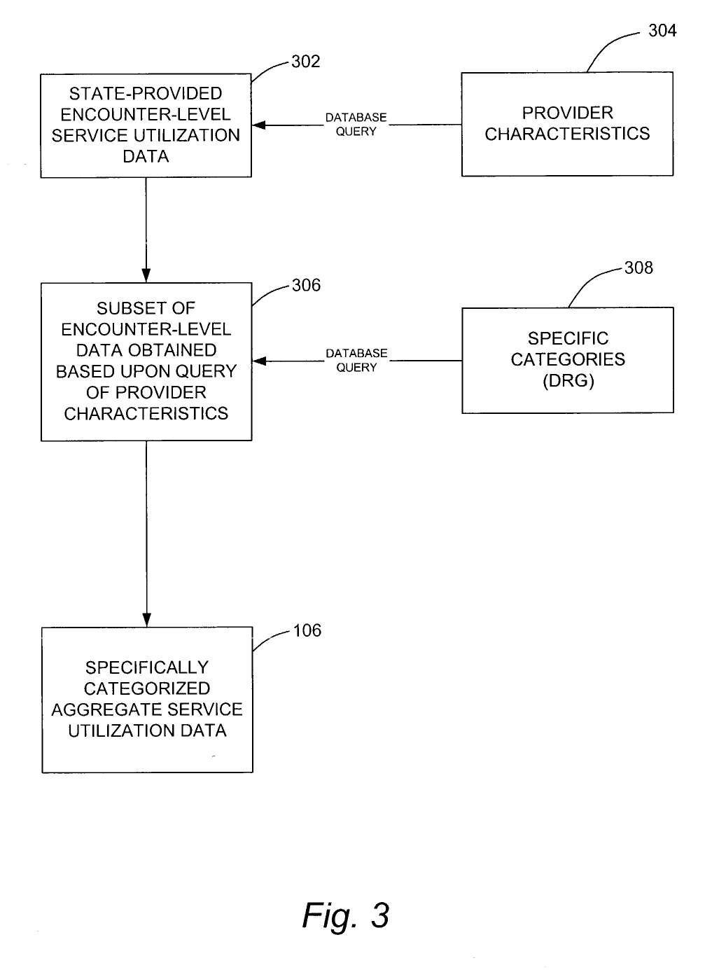

The aggregate service utilization data 106 is preferably derived by querying a large database of actual encounter data 302 (FIG. 3) for records that match the particular characteristics 304 (FIG. 3) of the subject service provider. This encounter data is typically collected by state governments from healthcare providers for entire state populations and made publicly available. The provider characteristics based upon which the query is performed may include, for example, the size and location of the facility maintained by the subject service provider. For each specific category (e.g., DRG), the data in the matching records are then summed or aggregated to obtain aggregate values. The aggregate values for each specific category may include, for example, the total covered amount for all encounters under the DRG or the total number of admissions categorized under the DRG. An example format and a method for generating specifically categorized service utilization data 106 will be presented in Subsection II.B below.

C. Creating Predictive Service Utilization Data

As illustrated in FIG. 1 and in a step 208 in FIG. 2, the aggregate service utilization data 106 and the provider service utilization data 104 are used to create a set of predictive service utilization data 108. The aggregate service utilization data 106 is preferably scaled and/or adjusted based upon utilization levels in the provider service utilization data 104 in order to obtain the predictive service utilization data 108.

The predictive service utilization data 108 is preferably also adjusted to take into account expected rates of inflation or change in healthcare costs and/or utilization levels. For example, aggregate costs in the aggregate service utilization data 106 can be adjusted to take into account the expected rate of inflation in healthcare costs between the time the data was collected and the subject time period for which the predicted data is being generated.

The predictive service utilization data 108 is preferably maintained in the same format and is categorized using the same specific categories as the aggregate service utilization data 106. Other formats, however, can be used. Methods for generating the predictive service utilization data 108 will be presented in Section III, below.

D. Determining a Financial Outcome

At a step 210, the terms of the rate schedule 102 are applied to the predictive service utilization data 108 to determine a financial outcome 110. In accordance with the illustrative embodiment, the rate schedule is specified in a standardized format including a rate structure (a set of rates) for each of a number of standardized rate categories. An example format of standardized rate categories will be presented in section II.A, below.

Service data from each specific category in the predictive service utilization data 108 is associated with one or more of the standardized rate categories. In some cases, all of the data of a specific category in the predictive service data utilization data 108 will be associated with only a single standardized rate category. In other cases, however, the data of a specific category may be apportioned between two or more standardized rate categories. In such cases some of the service data of the specific category may be covered by the rate structure of a first standardized rate category and some of the service data may be covered by the rate structure of a second rate category. Methods for associating service data with standardized rate categories will be described in detail in Section IV, below.

Once data is associated with a standardized category, the rate structure of the standardized category is applied to the data to determine an amount paid under the rate structure. The paid amounts for all of the predictive service utilization data 108 are determined and aggregated or summed to produce a total paid amount. The total paid amount represents an amount that would be paid (the financial outcome) under the subject rate schedule as applied to the predictive service utilization data.

As will be understood by one skilled in the art, the rate schedule 102 need not necessarily be provided in a standardized format. A standardized format, however, simplifies the process of applying the rate schedule to the predictive data 108 to determine a financial outcome.

As illustrated in a step 212, the inputs to the system can be altered to provide additional financial outcomes that can be compared. The system preferably allows a user to adjust terms of the rate schedule 102 and/or the utilization levels in the provider service utilization data 104 to determine the resulting effect on the financial outcome. The system can preferably also be configured to output the change or difference in the financial outcome that would result from a user-specified change to the rate schedule 102 and/or the provider utilization levels. Expected inflation assumptions and subject time periods can also be varied to determine resulting effects on the financial outcomes.

II. Input Data

A. The Rate Schedule

The rate schedule 102 is preferably specified in or translated into a standardized format including a rate structure for each of a number of standardized rate categories. The rate categories are preferably configured to correspond to categories based upon which rates are typically specified in schedules.

Table 1 (Appendix A) provides a set of standardized rate categories, specific categories, and classes of service in accordance with the illustrative embodiment. The first column of Table 1 lists several standardized rate categories. The second column lists, if applicable, any specific categories of service (DRGs) that are associated with the corresponding rate category and to which the rate category applies. The third column lists, if applicable, a corresponding class of service that includes the specific categories listed in the second column. In many cases, a rate category will not be associated with any specific categories or a class of service and in such cases, other mechanisms are used to associate data with these standardized categories as will be discussed in Section IV, below.

As will be understood by one skilled in the art, the invention is not limited by the selection of the standardized categories or the association of specific categories with standardized categories and classes of service provided in Table 1. Alternative configurations of standardized categories and associations of specific categories with standardized categories and general classes of service can be used in alternative embodiments to suit certain specific applications.

The standardized rate schedule 102 preferably enables a rate structure or a set of rates to be specified for each standardized rate category. In accordance with the illustrative embodiment, the rate structure for a standardized rate category can include: a base rate mechanism, an alternative rate mechanism, a stoploss rate mechanism, and a supplemental stoploss mechanism. The fields by which the rate mechanisms of a rate structure are specified in the illustrative embodiment are listed in Table 2, below.

TABLE 2
Rate Structure Fields

| Field | Description |
|---|---|
| one or more base | determines the type of value specified by the base rate |
| rate types | and how the base rate value is applied |
| one or more base | the rate, which can be a dollar/currency amount or a |
| rates | discount percentage, for example |
| alternative rate | preferably used when multiple rates must be applied |
| type | and the results compared in order to determine |
| | payment |
| alternative rate | the alternative rate, which can be a dollar/currency |
| | amount or a discount percentage, for example |
| stoploss rate type | determines the type of value specified by the stoploss |
| | rate and how the stoploss is applied, used to modify |
| | payments once certain thresholds of service or |
| | payments have been reached for a case |
| stoploss rate | determines the type of value specified by the stoploss |
| | and how the stoploss is applied, used to modify |
| | payments once certain thresholds of service or |
| | payments have been reached for a case |
| stoploss threshold | specifies when the stoploss applies |
| value | |
| supplemental | determines the type of value specified by the supple- |
| stoploss rate | mental stoploss rate and how the stoploss is applied, |
| type | used to modify payments once certain thresholds of |
| | service or payments have been reached for a case |
| supplemental | determines the type of value specified by the stoploss |
| stoploss rate | and how the stoploss is applied, used to modify |
| | payments once certain thresholds of service or |
| | payments have been reached for a case |
| supplemental | specifies when the supplemental stoploss applies |
| stoploss | |
| threshold value | |

Base rates types determine the type of value specified by the base rate and how the base rate value is applied. Some example base rate types are listed in Table 3, below.

TABLE 3
Rate Types

| Rate Type | Description |
|---|---|
| Per diem | the base rate specifies the payment per day of service or per |
| | visit |
| Per case | the base rate specifies the payment for an entire case or |
| | diagnosis |
| Discount | the base rate specifies a percent of billed charges, typically at |
| | a discount, at which the services will be paid |

An alternative rate type can be used when two or more rates must be applied and the results compared in order to determine payment. The alternative rate type can be specified as any one of the base rate types to create rates such as Lesser of Per Diem or Discount or Maximum of Per case or Discount. The alternative rate type can also be specified as “not applicable” in the case that the alternative rate is not used.

Stoploss rates can be used to limit payments once certain thresholds of service or payments have been reached for a case. Some example stoploss rate types are listed in Table 4, below.

TABLE 4
Stoploss Rate Types

| Rate Type | Description |
|---|---|
| First dollar | the stoploss rate specifies a percent of billed/covered |
| discount | charges, typically at a discount, at which the services |
| | of the entire case will be paid once a threshold amount |
| | of covered charges has been reached for a case |
| Length of Stay | the stoploss rate specifies a percent of billed/covered |
| % Discount | charges, typically at a discount, at which the covered |
| | charges for days above the threshold number of days |
| | for a case will be paid |
| Length of Stay | the stoploss rate specifics the payment per day of |
| Per Diem | service at which the days above the threshold number |
| | of days for a case will be paid |
| Above Threshold/ | the stoploss rate specifies a percent of billed/covered |
| Second Dollar | charges, typically at a discount, at which the covered |
| | charges above the threshold amount of covered charges |
| | will be paid |

The illustrative embodiment enables two stoploss rate types to be specified for each standardized category. Both a stoploss and a supplemental stoploss can be used for a single category to specify stoploss rates that apply at different thresholds.

In accordance with the illustrative embodiment, some or all of the rate/stoploss types, rates, and stoploss thresholds for a rate category can be specified as “not applicable.” If a stoploss is not used in a rate category of a rate schedule, the stoploss type, threshold, and rate are preferably specified as “not applicable.” If an alternative rate for a rate category is not used in a rate category of a rate schedule, the alternative rate type and alternative rate can be specified as “not applicable.”

In accordance with the illustrative embodiment, rate categories that are associated with specific diagnoses or conditions (e.g. cardiac care, maternity care) are matched with the data in any specific categories that are also associated with the same diagnosis or conditions. If a rate category does not exist for a specific diagnosis or condition, the data of any associated specific categories is processed under another set of rate categories is based upon “levels of care,” which will be described in greater detail in Subsection ll.C, below.

When data of a specific category is processed based upon “levels of care,” the data of the specific category is allocated among and processed under a number of “level of care” rate categories. In Table 1, the rate categories that do not have any specific categories associated with them are used as “level of care” categories. In addition, some of the categories that do have specific categories associated with them can also serve as “level of care” categories. The application of rate categories to service data will be discussed in detail in Section IV, below.

As will be understood by one skilled in the art, the rate schedule can be configured to enable more complex rate mechanisms to be used by including additional fields in a rate schedule. Furthermore, types of rates in addition to the example rate types described herein can be defined and provided for use to enable the standardized rate schedule 102 to specify rates more particularly or accurately.

B. Creation of Specifically Categorized Aggregate Service Utilization Data

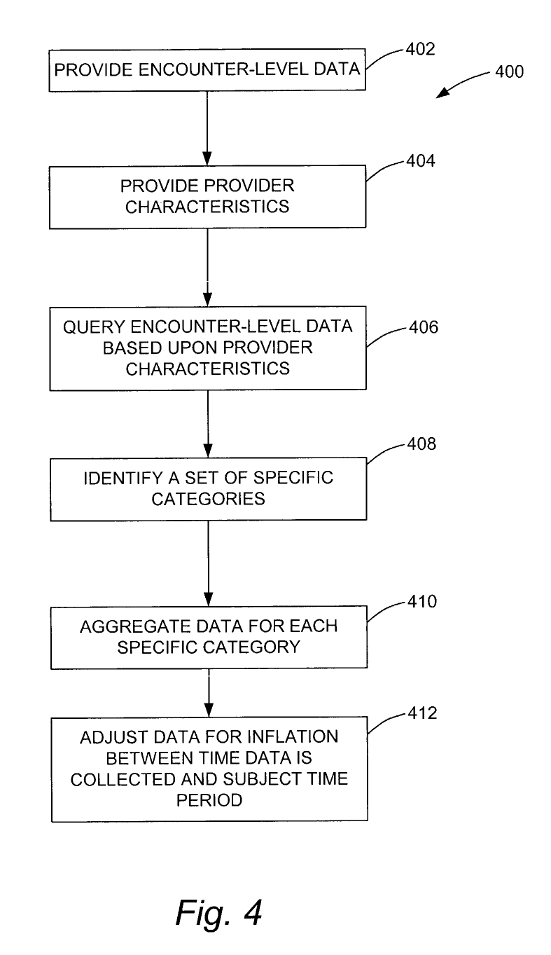

FIG. 3 illustrates sources from which the specifically categorized aggregate service utilization data 106 can be derived. FIG. 4 illustrates a method 400 for creating the specifically categorized aggregate service utilization data 106.

As illustrated in FIG. 3, the specifically categorized aggregate service utilization data 106 is preferably derived from accumulated encounter level data 302. Most state governments require all hospitals and medical service providers within the state to provide data on each patient encounter or incident for statistical reporting purposes. This raw encounter-level data 302, which is accumulated by states and is made publicly available, provides a detailed data source based upon which future service utilization can be predicted. Each record in the encounter-level data typically includes a date, a diagnosis (e.g., a DRG code), a length of stay in the hospital for the case, as well as billed charges for the case. At a step 402 of the method 400, the encounter level data 302 is provided.

The encounter-level data 302 provided by the states includes sufficient information to create a subset 306 of all of the records that match the particular characteristics of the subject service provider. In order to identify this subset 306, a set of provider characteristics 304 for the subject service provider can be used to query the encounter-level data. In accordance with the illustrative embodiment, the provider characteristics 304 can include, for example:

the state in which the subject service provider is located;

the type of facility operated by the subject service provider (e.g., academic center, trauma center, cancer center, psychiatric facility, long-term care facility, children's hospital, rehabilitation facility, government hospital, urban community hospital, rural community hospital);

the size of the subject service provider's facility (e.g., under 100 beds, 100 to 250 beds, 250 to 500 beds, or 500 or more beds);

the type of population covered in the subject rate schedule (e.g., private insurance, senior, Medicaid, self-pay, or other); and

a product class under which services are to be covered (e.g., HMO, PPO, POS, or indemnity).

At a step 404 of the method 400, the provider characteristics are provided. At a step 406, the provider characteristics 304 are used to query the encounter-level data 302 to obtain the subset 306.

At a step 408, a set of specific categories 308 are identified. In accordance with the illustrative embodiment, Diagnostic Related Grouping codes (DRGs) are used to represent the specific categories 308. In some cases, data may not be able to be associated with an available DRG and in such cases additional codes can be created or a “miscellaneous” code can be used to categorize the data.

At a step 410, the data from the subset 306 is aggregated or summed for each specific category 308 to obtain the specifically categorized aggregate service utilization data 106. In the illustrative embodiment, the subset 306 is queried based upon DRGs and the data for each DRG is summed or aggregated.

At a step 412, the data for each DRG is preferably adjusted to take into account actual and/or expected inflation between the time the encounter-level data 302 was collected and the subject time period for which a financial outcome is being determined. Expected or actual inflation rates based upon which the data can be adjusted can include, for example, inflation in billed charges, inflation in patient admissions or cases, and inflation in average length of stay. These rates are preferably used to adjust particular fields within the data to which the rates are applicable in order to enable the data to more accurately project utilization during the subject time period. In alternative embodiments, inflation can be taken into account in other stages of the analysis.

As will be understood by one skilled in the art, a single set of queries, one for each specific category, can be performed by including the DRG in addition to the provider characteristics 304 when querying they encounter-level data 302. The results of each query can then be summed or aggregated to produce the results for each specific category.

C. Composition of Specifically Categorized Aggregate Service Utilization Data

Table 5 (See Appendix B) lists the variables that are maintained for each specific category or DRG in accordance with the illustrative embodiment. The variables for each DRG can be maintained as one record in a larger database table.

The first variable in Table 5 provides an identification of the specific category (DRG) to which the data applies. The remaining variables provide various service utilization data that can be used to determine aggregate amounts paid under various rate mechanisms. For example, a discount rate specifies payment as a percentage discount from billed charges. The second variable, “Category_billed,” provides total billed charges for the DRG based upon which a total payment can be derived using a discount rate.

Services are often provided and rates are often specified based upon a level of care rendered the patient. “Levels of care” can include, for example:

critical care, such as care rendered a patient in an intensive care unit;

acute care, also known as “medical/surgical” or “medsurg,” which is the typical level of care provided a patient during a hospital stay; and

subacute care, also known as transitional care, which can include rehabilitation or skilled nursing facility (SNF) services.

Services can also be categorized based upon the age category of the patient. Patients can be categorized as adults, pediatrics, and babies. The seventh through the fifteenth variables represent “level of care” variables that specify provider data based upon nine combinations of age groups and levels of care. As will be discussed in additional detail in Section IV, the data provided in these nine variables is used in associating utilization levels with rate mechanisms when there is not a match between a rate category diagnosis or condition and an associated specific category.

Some payment mechanisms provide stoploss mechanisms where different rates apply once a threshold number of days or a threshold amount of billed charges are reached for a case. Accordingly, additional variables provide aggregate amounts for cases categorized by threshold levels of billed charges or length of stay.

Table 5 provides only an example set of variables. As will be understood by one skilled in the art, additional variables can be determined and added to the specifically categorized aggregate service utilization data 106 to enable different or more complex stoploss mechanisms to be handled.

D. Generally Classified Historical Provider Service Utilization Data

The generally classified historical provider service utilization data 104 represents generally classified levels of service utilization for the subject provider during a sample time period. In accordance with the illustrative embodiment, the classes include:

1. cardiac-related services;

2. maternity-related services;

3. pediatrics-related services;

4. behavioral health-related services;

5. transplant-related services; and

6. a medical/surgical related class covering all other services not covered by the aforementioned classes.

For each class of services, the provider service utilization data preferably provides at least the data shown in Table 6, below.

TABLE 6
Service Utilizations by Class

| Variable | Description |
|---|---|
| Class_billed | Includes all billed charges within the class of |
| | service |
| Class_admits | The number of patient admissions within the class |
| | of service |
| Class_critical_days | Total number of days spent by patients under |
| | critical care |
| Class_acute_days | Total number of days spent by patients under |
| | acute care |
| Class_subacute_days | Total number of days spent by patients under |
| | subacute care |
| Class_total_days | Total number of days spent by patients within the |
| | class of service, which should equal the sum of |
| | Class_critical days, Class_acute_days, and |
| | Class_subacute_days |

In the illustrative embodiment, the provider service utilization data includes 24 variables —four variables for each of six classes of service. The fifth variable for each class, “Class_total_days,” can be derived by summing the Class_critical_days, Class_acute_days, and Class_subacute days variables. This data provides an indication of the general levels of service utilization experienced by the provider and also an indication of the relative distribution of services across the given classes of service and levels of care.

Some additional processing of the provider data 104 is preferably also performed in order to create totals of data across all of the generalized classes. These additional totals are listed in Table 7, below.

TABLE 7
Total Service Utilizations

| Variable | Description |
|---|---|
| Total_billed | Total of billed charges for all classes of service |
| Total_admits | The number of patient admissions for all classes of |
| | service |
| Total_days | Total number of days spent by patients within the all |
| | classes of service |

The provider service utilization data preferably accounts for all of the services provided by the provider during the sample time period. Accordingly, the sum of “Class_billed” for all 6 classes, “Total_billed,” should equal the total amount billed by the provider during the sample period. The sum of “Admits” for all the classes, “Total_admits,” preferably represents the total number of admissions serviced by the provider during the sample period. In addition, the sum of “Class_total_days” for all the classes, “Total_days,” preferably represents the total number of days of service provided by the provider during the sample period.

These calculated totals are preferably used to determine distributions of service utilizations for each class and level of care relative to total utilization amounts, as will be discussed in Section III, below.

As will be understood by one skilled in the art, the invention is not limited by the particular set of classes or the variables included in the provider utilization data as described with respect to the illustrative embodiment. In alternative embodiments the classes and variables can be defined differently to suit particular implementation needs.

III. Creating Predictive Service Utilization Data

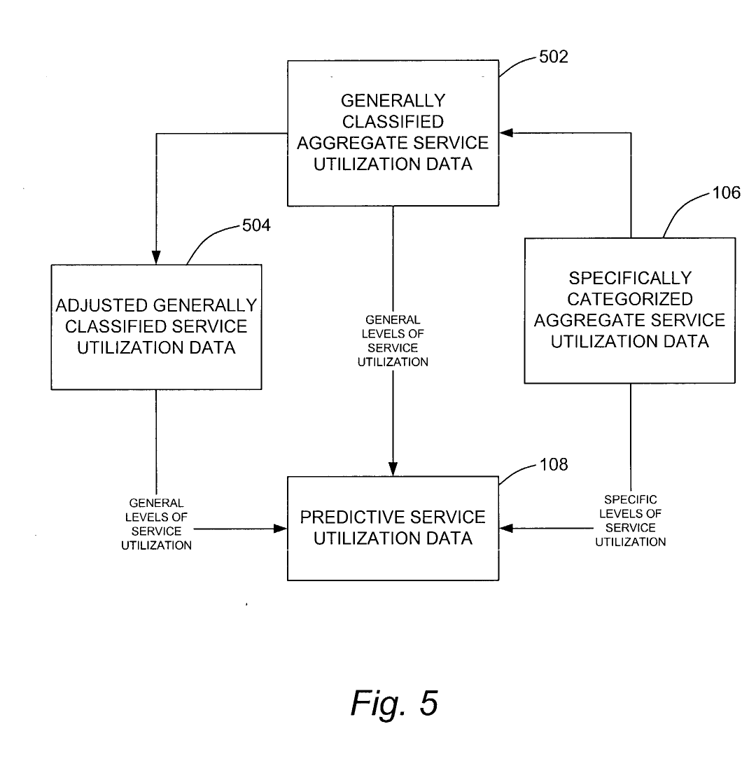

FIG. 5 is a high-level diagram of the creation of the predictive service utilization data 108 in accordance with the illustrative embodiment.

A set of generally classified aggregate service utilization data 502 is preferably created from the specifically categorized aggregate service utilization data 106. The generally classified aggregate service utilization data 502 is preferably created in the same format as the provider service utilization data 104 and provides a second set of data upon which a distribution of services can be based. As discussed above, Table 1 (Appendix A) provides a mapping from specific categories (such as DRGs) to generalized classes. The mapping can be used to query the aggregate service utilization data to extract data separately for each of the generalized classes. The queried data for each class is then summed to create the generally classified aggregate service utilization data 502. The generally classified aggregate service utilization data 502 provides general levels of service utilization that are used to create a set of adjusted generally classified service utilization data 504 and to create the predictive service utilization data 108.

The set of adjusted generally classified service utilization data 504 is created by adjusting levels of service utilization of the provider data 104 to account for levels of utilization reflected in the generally classified aggregate service utilization data 502. Creation of the adjusted generally classified service utilization data 504 will be discussed in greater detail in Subsection A, below.

The general levels of service utilization of the adjusted service utilization data 504 and the generally classified aggregate service utilization data 502 are next applied to adjust the specific levels of utilization in the aggregate data 106. Application of the general levels of utilization to the specific levels will be discussed in greater detail in Subsection B, below.

A. Creating the Adjusted Generally Classified Services Utilization Data

In certain instances, the user may not want to rely completely upon the distribution of services represented by the provider service utilization data 104. The user may have concerns about the reliability of the provider service utilization data supposing, for example, that the data was collected over a short time period or that the data is based upon the experience of a relatively small provider. Additionally, the user may want to perform an analysis based upon distributions of service obtained from a larger source of data, such as, for example, the aggregate service utilization data 106 that is already available.

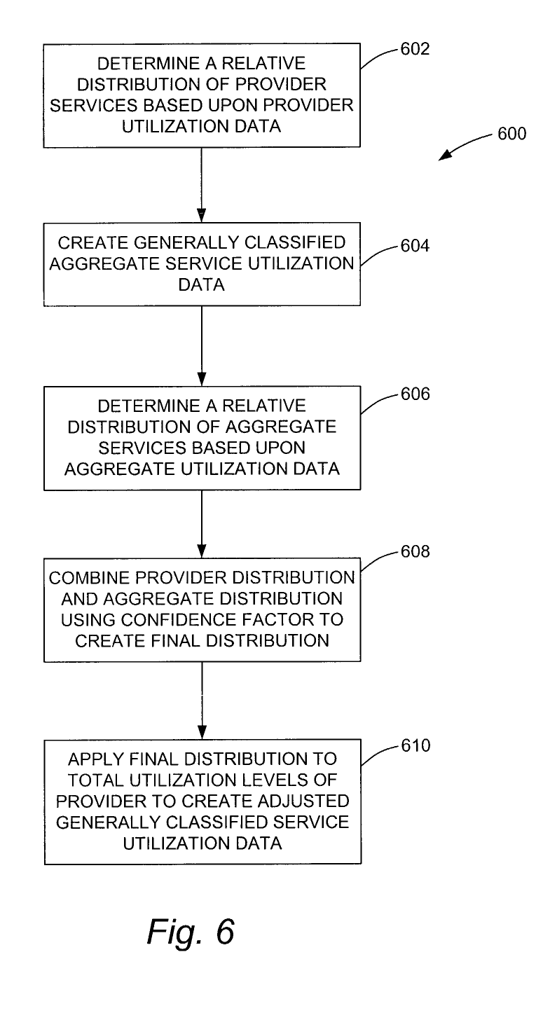

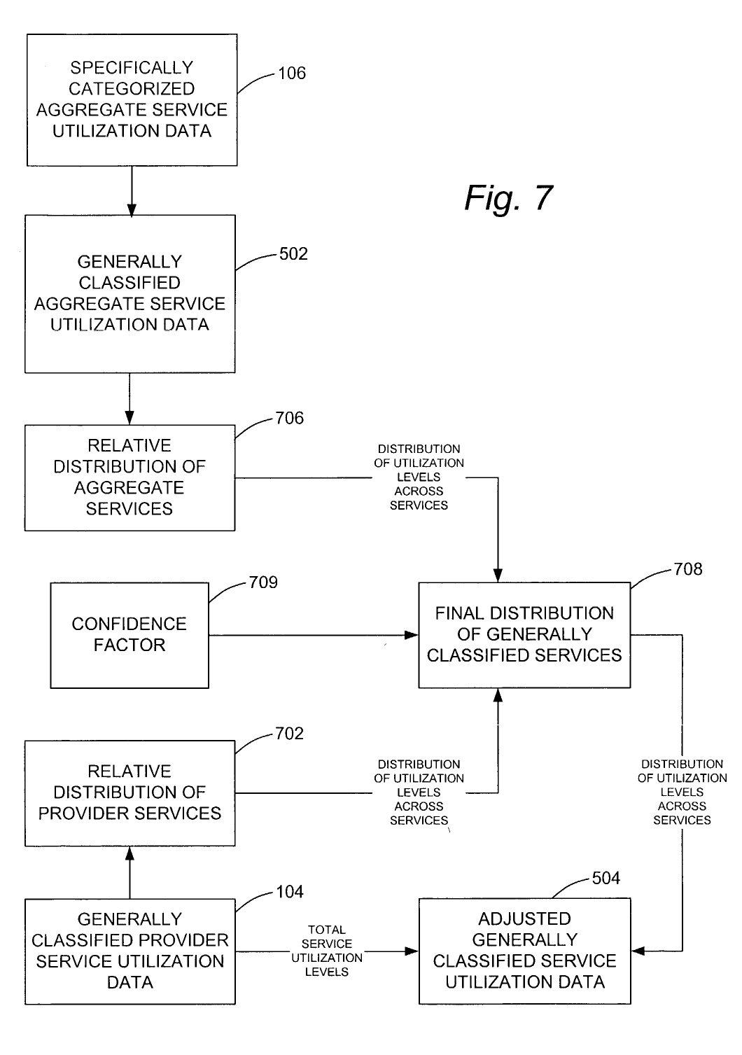

FIG. 6 illustrates a method 600 in accordance with which the provider service utilization data 104 can be adjusted, using a confidence factor, to reflect an alternative distribution of services. The combined distribution is then applied to the “Total” utilization levels from the provider data 104 to create the adjusted generally classified service utilization data 504. FIG. 7 illustrates a data flow in accordance with the method 600.

At a step 602 of the method 600, a relative distribution of provider services 702 (FIG. 7) is determined based upon the provider service utilization data 104. In accordance with the illustrative embodiment, the proportions listed in Table 8 are preferably determined for each class.

TABLE 8
Service Distribution Proportions by Class

| Variable | Description |
|---|---|
| Class_portion_billed | Ratio of the billed amount for the class |
| | to the total billed amount for all classes, |
| | which is equal to Class_billed/ |
| | Total_billed |
| Class_portion_days | Ratio of the number of days spent by |
| | patients in the class to the total number |
| | of days for all classes, which is equal to |
| | Class_total_days/Total_days |
| Class_portion_admits | Ratio of the number of admissions for |
| | the class to the total number of |
| | admissions for all classes, which is |
| | equal to Class_admits/Total_admits |
| Class_portion_critical_days | Ratio of the number of critical care days |
| | for the class to the total number of days |
| | for the class, which is equal to |
| | Class_critical_days/Class_total_days |
| Class_portion_acute_days | Ratio of the number of acute care days |
| | for the class to the total number of days |
| | for the class, which is equal to |
| | Class_acute_days/Class_total_days |
| Class_portion_subacute_days | Ratio of the number of subacute care |
| | days for the class to the total number of |
| | days for the class, which is equal to |
| | Class_subacute_days/ |
| | Class_total_days |

The distribution of billed charges among the classes is specified by Class_portion_billed for each class, the sum of which for all the classes should equal 1. The distribution of days among the classes is specified by Class_portion_days for each class, the sum of which for all the classes should equal 1. The distribution of admissions among the classes is specified by Class_{—portion}_admits for each class, the sum of which for all the classes should equal 1. The distribution of days by “level of care” within a class is specified by the variables Class_portion_critical_days, Class_portion_acute_days, and Class_portion_subacute_days, which preferably sum to 1.

At a step 604, the set of generally classified aggregate service utilization data 502 (FIGS. 5 and 7) is created from the specifically categorized aggregate service utilization data 106. As discussed above, the generally classified aggregate service utilization data 502 is preferably created in the same format as the provider service utilization data 104 and provides a second set of data upon which a distribution of services can be based.

At a step 606, a relative distribution of aggregate services 706 (FIG. 7) is determined based upon the aggregate service utilization data 106. The distribution of aggregate services 706 is preferably calculated in the same manner and in the same format as the distribution of provider services 702.

At a step 608, a final distribution of generally classified services 708 (FIG. 7) is determined by combining the distribution of provider services 702 and the distribution of aggregate services 706. The final distribution of generally classified services 708 preferably also has the same format as the distribution of provider services 702. In accordance with the illustrative embodiment, a user-supplied confidence factor (CF) 709 (FIG. 7) ranging from 0 to 1 is used to calculate a weighted sum of each distribution variable for each class based upon the provider distribution 702 and the aggregate distribution 706. Each variable for each class in the final distribution can be determined as in the following example:

$$Class\_portion {\_billed}_{final} = \begin{matrix}Class\_portion {\_billed}_{provider} \times CF + \\ Class\_portion {\_billed}_{aggregate} \times ( 1 - CF )\end{matrix}$$

A confidence factor closer to 1 places more emphasis on the distribution in the provider data 102 while a confidence factor closer to 0 places more emphasis on the distribution in the aggregate data 106.

At a step 610, the final distribution of generally classified services 708 is applied to the calculated totals (Table 7) from the provider utilization data 102 to produce the set of adjusted generally classified service utilization data 504. The adjusted generally classified service utilization data 504 is preferably calculated in two stages. At a first stage, the final distribution 708 is applied to Total_billed, Total_days, and Total_admits from the provider utilization data 102 to determine Class_billed, Class_total_days, and Class_admits for each class of service. These first three final distribution variables can be determined for each class as follows:

Class_billed_{adjusted}=Class_portion_billed_{final}×Total_billed_{provider}

Class_admits_{adjusted}=Class_portion_admits_{final}×Total_admits_{provider}

Class_total_{—days}_{adjusted}=Class_portion_days_{final}×Total_days_{provider}

Once the number of Total_class_days has been determined for a class, Critical_days, Acute_days, and Subacute_days can be determined for the class as follows:

Class_critical_days_{adjusted}=Class_portion_critical_days_{final}×Class_total_days_{adjusted}

Class_acute_days_{adjusted}=Class_portion_acute_days_{final}×Class_total_days_{adjusted}

Class_subacute_days_{adjusted}=Class_portion_subacute_days_{final}×Class_total_days_{adjusted}

Accordingly, a new set of generally classified utilization data 504 is created based upon the total of Total_billed, Total_admits, and Total_days from the provider service utilization data 104 and from the distribution in the final distribution of generally classified services 708. The Total_billed, Total_admits, and Total_days variables preferably remain unchanged from the provider data 104 to the adjusted data 504. In this manner the overall utilization levels and billed amounts of the subject provider are maintained. The distribution of services, however, is adjusted, based upon the compensation factor 709 to reflect a distribution based upon a larger population such as the aggregate service utilization data 106.

As will be understood by one skilled in the art, distributions other than the aggregate distribution 706 can be combined with the provider distribution 702. Alternatively or additionally, distributions can be manually created or manipulated before being applied to the totals of the provider service utilization data 104.

In order to simplify the form and content of the provider data 104, the user can provide only total utilization levels of Total_billed, Total_admits, and Total days by using a confidence factor of 0. The confidence factor of 0 causes the class-specific utilization levels to be ignored. The distribution of services from the aggregate data 106 is then applied to these total utilization levels to create the adjusted generally classified services utilization data 504.

B. Applying the Adjusted Utilization Data to the Aggregate Data

The aggregate service utilization data 106 preferably includes aggregate data for many hospitals but is not representative of a particular provider. The aggregate data 106 is therefore scaled and/or adjusted to create the predictive service utilization data 108, which represents predicted levels of service utilization for the subject service provider. The general levels of service utilization represented in the adjusted utilization data 504 are preferably applied to the specific levels of service utilization of the aggregate data 106 in order to create the predictive data 108.

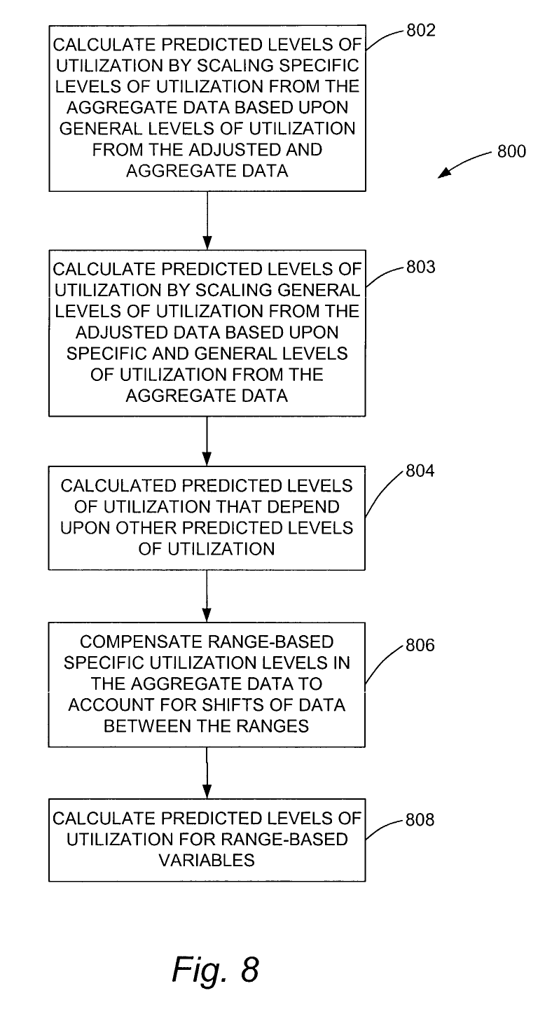

FIG. 8 illustrates a method 800 in accordance with the illustrative embodiment for applying the adjusted utilization data 504 and the generally classified aggregate service utilization data 502 to the aggregate data 106 to create the predictive service utilization data 108. The method 800 is preferably performed for each specific category in the aggregate data 106 to create a new set of predictive data 108 for the specific category.

The predictive service utilization data 108 is preferably maintained in the same format and is categorized using the same specific categories, which are shown in Table 5 (Appendix B), as the aggregate service utilization data 106.

Table 9 (Appendix C) shows formulas for determining the values of the predictive data. In Table 9, the first column includes reference numbers for identifying the variables, the second column includes the names of the predictive variables for a category (which are the same names as the aggregate variables), and the third column provides a formula for determining the value of the predictive variable in accordance with the illustrative embodiment. When no subscript is present for a variable, the variable is generally the corresponding variable from the specific category in the aggregate utilization data 106. The subscript “adjusted” is used to identify variables from the adjusted generally classified utilization data 504. The subscript “aggregate” is used to identify variables from the generally classified aggregate service utilization data 502. When a “class” variable is referred to, the class is the class that corresponds to the specific category—these classes are identified in Table 1 (Appendix A). The subscript “predicted” is used to refer to predicted variables of the same specific category that have already been calculated.

At a step 802, some of the predicted variables are calculated by scaling specific utilization levels of the aggregate data 106 based upon general utilization levels of the adjusted data 504 and general utilization levels from the generally classified aggregate data 502. Many of the predicted variables in this set can be calculated by scaling the corresponding variable from the aggregate data 106 by the ratio of (a) the class variable from the adjusted generally classified service utilization data 504 and (b) the corresponding class variable from the generally classified aggregate service utilization data 502. For example, the predicted total number of admissions for a category can be calculated as follows:

$${Category\_admits}_{predicted} = Category\_admits \times \frac{Class\_total {\_admits}_{adjusted}}{Class\_total {\_admits}_{aggregate}}$$

wherein

Category_admits_{predicted} represents the predicted number of admissions for the category;

Category_admits represents the number of admissions for the category (e.g., DRG) taken from the aggregate service utilization data 106;

Class_total_admits_{adjusted} represents the total number of admissions for a class of services that includes the category being predicted taken from the adjusted generally classified service utilization data 504; and

Class_total_admits_{aggregate} represents the total number of admissions for a class of services that includes the category being predicted taken from the generally classified aggregate service utilization data 502.

At a step 803 some of the predicted variables are calculated by scaling general utilization levels from the adjusted data 504 based upon specific utilization levels in the aggregate data 106 and general utilization levels from the generally classified aggregate data 502. For example, the predicted total of billed charges for the category can be calculated as follows:

$${Category\_billed}_{predicted} = {Class\_billed}_{adjusted} \times \frac{Category\_days}{Class\_total {\_days}_{aggregate}} .$$

At a step 804, some predicted variables that depend upon predicted variables calculated in step 802 are calculated. Some of these variables may be determined by applying a ratio from the aggregate data 106 to a newly calculated predicted variable. For example, the predicted number of adult admissions for the category can be calculated as follows:

$${Adult\_admits}_{predicted} = {Category\_admits}_{predicted} \times \frac{Adult\_admits}{Category\_admits} .$$

At a step 806, range-based predicted variables are preferably compensated for shifts in the defined ranges. The range-based variables include variables that specify utilization levels for admissions with characteristics in specified ranges. In the illustrative embodiment,

1. having billed charges within certain specified ranges (e.g., $0 to $25,000, $25,000 to $50,000, $50,000 to $75,000, etc.);

2. having average billed charges per day within certain specified ranges (e.g., $0 to $1000, $1000 to $2000, $2000 to $3000, etc.); and

3. having a length of stay within certain specified ranges (e.g., 1 to 2 days, 3 to 4 days, 5 to 6 days, etc.).

For example, the predicted average billed charges per admission may be different than the average billed charges per admission for the aggregate data. To take this difference into account, the distribution of levels of utilization among the variables that are based upon ranges of billed charges per admission are preferably adjusted to reflect the increased or decreased average billed charges per admission.

Suppose, for example, that average billed charges per admission for the predictive data are 10% greater than for the aggregate data. There should be a shift of billed charges from Billed_$0to25 to Billed_$25to50 since, on average, higher total amounts would be billed for each admission and therefore fall into the Billed_$25to50 range rather than the Billed_$0to25 range.

Before calculating these range-based predicted variables, the corresponding variables from the aggregate data 106 are preferably compensated to take these shifts into account.

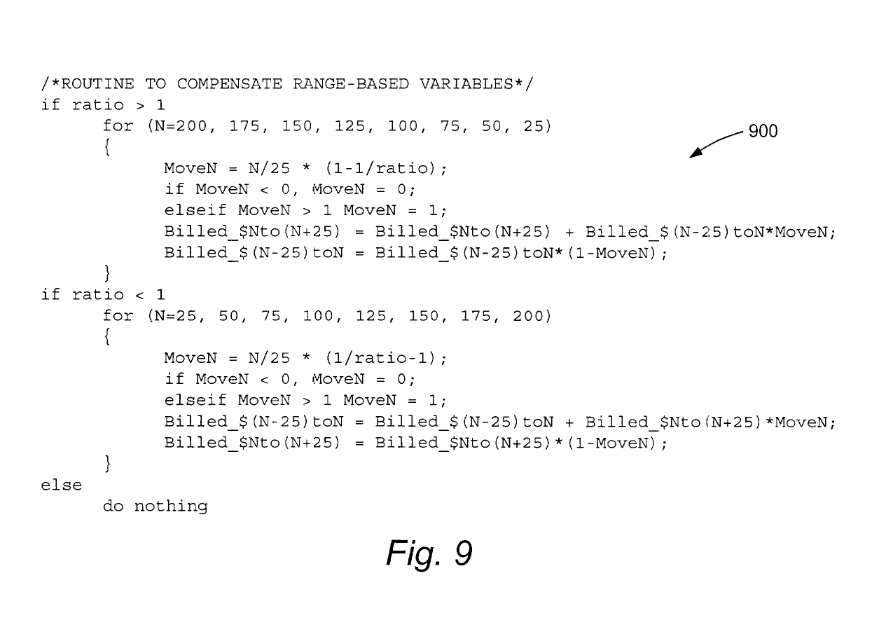

FIG. 9 illustrates pseudocode routine 900 configured to perform this adjustment for the range variables Billed_$0to25 through Billed_over$200. The routine 900 preferably acts upon the aggregate variables “in place” such that modifications made to the aggregate variables in previous iterations are available in subsequent iterations. After the routine 900 completes, the compensated variables preferably retain the same names as the original variables. The routine for the Billed_$0to25 through Billed_over$200 variables relies upon the change in billed charges per admission between the aggregate data 106 and the predictive data 108. This change is provided by the variable “ratio,” which is the ratio of (a) the predicted Billed amount per admission to (b) the aggregate billed amount per admission, and which is calculated as follows:

$$ratio = \frac{\frac{{Category\_billed}_{predicted}}{{Category\_admits}_{predicted}}}{\frac{Category\_billed}{Category\_admits}} .$$

The routine 900 follows one of three branches depending upon the value of “ratio.” If the value of “ratio” is 1, then no further processing is necessary since there has been no change in the average amount billed per admission.

If the value of ratio is greater than 1, meaning that the average billed amount per admission has increased, then data (billed amounts) are shifted from lower ranges to higher ranges. The variables are processed from Billed_over$200 down to Billed_$0to25 in order to account for the shift from lower ranges to higher ranges. The temporary variable MoveN represents the portion of the billed amount to be moved from an adjacent lower-range variable to a higher-range variable. This portion is deducted from the lower-range variable and added to the higher-range variable. The divisor of 25, used to calculate MoveN, represents the $25,000 increment between ranges in this first group.

If the value of ratio is less than 1, meaning that the average billed amount per admission has decreased, then data (billed amounts) are shifted from higher ranges to lower ranges. The variables are processed from Billed_$0to25 up to Billed_over$200 in order to account for the shift from higher ranges to lower ranges. The temporary variable MoveN represents the portion of the billed amount to be moved from an adjacent higher-range variable to a lower-range variable. This portion is deducted from the higher-range variable and added to the lower-range variable.

At a step 808, once the routine 900 has been applied to the range-based variables Billed_$0to25 through Billed_over$200 in the specific category of the aggregate data 106, the final adjustment, listed in Table 9, can be applied. For example, Billed_$0to25, can then be calculated as follows:

$$Billed\_\$0 to {25}_{predicted} = Billed\_\$0 to 25 \times \frac{{Category\_billed}_{predicted}}{Category\_billed} .$$

The remaining variables in the first group above, Admits_$0to25 through Admits_over$200 and Days $0to25 through Days_over$200, can also be calculated using the same routine 900 and the same “ratio” variable since the ranges for these range-based variables are defined in the same way.

The ranges of the variables in the second group above, Billed_avg_{—}0to1 through Billed_avg_over10, Admits_avg_{—}1to2 through Admits_avg_over10, and Days_avg_{—}1to2 through Days_avg_over10 are all based upon the average charges per day. For this group the same routine 900 can also be applied, but the values of N should reflect the different ranges used in the second group. In the first branch of the routine 900, N should take on the values (10, 9, 8, 7, 6, 5, 5, 3, 2, 1) and in the second branch (1, 2, 3, 4, 5, 6, 7, 8, 9, 10). Also, the divisor of 25, used to calculate MoveN in the first group, should be changed to 1, to reflect the $1000 increment between the variables in the range. The variable Billed_$Nto(N+25), for example, is replaced with the variable Billed_avg_Nto(N+1) in the new routine. Changes to the remaining variables will be apparent to one skilled in the art. For the second group the “ratio” is calculated as follows:

$$ratio = \frac{\frac{{Category\_billed}_{predicted}}{{Category\_days}_{predicted}}}{\frac{Category\_billed}{Category\_days}} .$$

The ranges of the variables in the third group above, Billed_LOS_{—}1to2 through Billed_LOS15over, Admits_LOS_{—}1to2 through Admits_LOS15over, and Days_LOS_{—}1to2 through Days_LOS15over are all based upon the length of stay. For this group the same routine 900 can also be applied, but the values of N should reflect the different ranges used in the third group. In the first branch, N should be (14, 12, 10, 8, 6, 4, 2) and in the second branch (3, 5, 7, 9, 11, 13, 15). Also, the divisor of 25, used to calculate MoveN in the first group, should be changed to 2, to reflect the 2-day increment between the variables in the range. The variable Billed_$Nto(N+25) in the first group, for example, is replaced with the variable Billed_LOS(N+1)to(N+2) in the new routine. Changes to the remaining variables will be apparent to one skilled in the art. For the third group, the “ratio” is calculated as follows:

$$ratio = \frac{\frac{{Category\_days}_{predicted}}{{Category\_admits}_{predicted}}}{\frac{Category\_days}{Category\_admits}} .$$

At the step 808, after the range variables in the second and third groups have been compensated for any shifts in the ranges at the step 806, these range variable are preferably also adjusted using the formulas in Table 9.

The predictive service utilization data 108 is preferably complete once the method 800 has been applied to all of the variables for each specific category in the aggregate data 106.

IV. Determining a Financial Outcome

In accordance with one embodiment, the specific categories of the predictive data 108 are processed one by one to determine a paid amount for each specific category under the subject rate schedule. As each specific category is processed, the paid amount is added to an aggregate total. Once all of the specific categories have been processed, the aggregate total represents the predicted total amount that would be paid under the subject rate schedule.

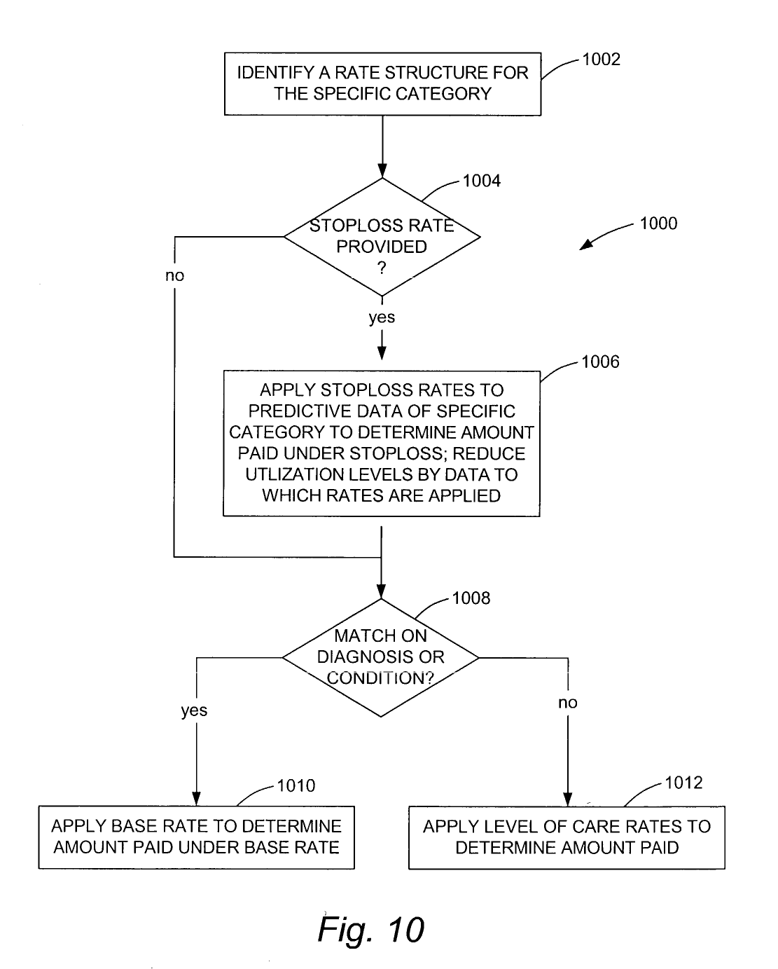

FIG. 10 illustrates a method 1000 in accordance with the illustrative embodiment for processing each specific category to determine a total amount paid under the subject rate plan.

At a step 1002, a rate structure for the rate category associated with the specific category is identified. Table 1 (Appendix A) provides a mapping of specific categories (DRGs) to rate categories.

At a decision step 1004, if a stoploss rate and/or a supplemental stoploss rate are provided in the rate structure, control flows to a step 1006. Otherwise, the stoploss types for the rate category are all “not applicable” and control flows to a step 1008 skipping the step 1006.

At the step 1006, any stoploss rate mechanisms provided in the identified rate structure are applied to the predictive data of the specific category. Suppose, for example, the stoploss rate type is “First Dollar Discount,” the stoploss threshold value is $40,000, and the stoploss rate is 80%. In this case, the variables Billed$MtoN can be used to determine the amount of billed charges subject to the stoploss rate. Clearly none of the billed charges specified in the variable Billed_$0to25 will be subject to the stoploss rate since this variable includes only billed charges for admissions having billed charges of less than $25,000. On the other hand, all of the billed charges specified in the variables Billed_$50to75 through Billed_over$200 will qualify under the rate since the values specified by these variables are for admissions where the billed charges are greater than $50,000. In addition, a portion of the billed charges in the Billed_$25to50 variable should also be billed at the stoploss rate since some of the billed charges are presumably for admissions with billed charges of less than $40,000 and some are for admissions with billed charges of greater than $40,000.

An interpolation technique can be used to identify a portion (Subject_portion) of the data in a range-based variable that qualifies under a threshold between the limits of the range as follows:

$$Subject\_portion = \frac{40 , 000 - 25 , 000}{50 , 000 - 25 , 000} \times Billed\_\$25 to \$50 .$$

Once the total amount subject to the stoploss rate of 80% has been aggregated (Subject_amount), the amount paid under the stoploss mechanism can be calculated as follows:

Paid_amount=Subject_amount ×rate

Finally, the data in the specific category is preferably adjusted to reflect the data that has been processed. In the present example, Billed_$50to75 through Billed_over$200 should all be reduced to zero, Billed_$25to50 should be reduced by the Subject portion, and Category_billed should be reduced by the Subject_amount. The adjusting of the data in the specific category to account for processed data ensures that when another rate mechanism is applied (e.g., another stoploss mechanism or a base rate), data is not processed twice under two rate mechanisms.

As will be understood by one skilled in the art, the example application of the “First Dollar Discount,” can be adapted to calculate the paid amount under other stoploss mechanisms in accordance with the invention.

At a decision step 1008, if there is a match between a rate category and a specific category based on diagnosis or condition, control flows to a step 1010. Otherwise, “level of care” rate categories are applied, and control flows to a step 1012.

At the step 1010, the base rate and alternative rate mechanisms provided in the identified rate structure are applied to the predictive data of the specific category. The amount paid under the base or alternative rate mechanism can be calculated as follows:

Paid_amount=Subject_amount ×rate

In the case the base rate type is “Per diem,” for example, and the base rate is $X, the paid amount will be:

Paid_amount=Category_days ×$X

In the case the base rate type is “Per case,” for example, and the base rate is $X, the paid amount will be:

Paid_amount=Category_admits ×$X

In the case the base rate type is “Discount,” for example, and the base rate is X%, the paid amount will be:

Paid_amount=Category_billed ×X%

As will be understood by one skilled in the art, these example applications of the base rates can be adapted to calculate the paid amount under other rate mechanisms in accordance with the invention.

In the case an alternative rate is specified, the amount paid under the alternative rate is calculated and then compared to the amounts paid under the base rate to determine the amount paid.

The step 1012 is preferably only reached in the case a match is not found based on diagnosis or condition between a rate category and a specific category. In this case, a set of variables that specify utilization levels by level of care are processed under a set of “level of care” rate categories. In the illustrative embodiment, these utilization levels for the specific category are allocated to the “level of care” rate categories as shown in Table 10.

TABLE 10
Allocation of Data to Level of Care Rate Categories

| Variable | Allocation of Data to Rate Categories |
|---|---|
| Acute_adult_days | For surgical categories: 100% Surgery |
| | For non-surgical categories: 95% Medicine, |
| | 5% Hospice |
| Critical_adult_days | For cardiac categories: 90% CCU, 7% TCU, |
| | 3% DOU |
| | For non-cardiac categories: 90% GICU, 7% TCU, |
| | 3% DOU |
| Subacute_adult_days | 75% SNF, 25% Rehabilitation |
| Acute_peds_days | For surgical categories: 100% Pediatric Surgery |
| | For non-surgical categories: 100% Pediatric |
| | Medicine |
| Critical_peds_days | 100% PICU |
| Subacute_peds_days | 75% SNF, 25% Rehabilitation |
| Acute_baby_days | 90% Sick Baby |
| Critical_baby_days | 75% NICU, 25% Sick Baby |
| Subacute_baby_days | 50% Boarder Baby, 50% Nursery |

Table 10 provides an allocation of utilization (days of service, in this case) to each of several “level of care” rate categories. The percentages listed in Table 10 for the allocations are representative of observed distributions and may be changed based upon additional empirical data in alternative implementations.

Suppose, for example, that the specific category in this case is DRG 104 for Cardiac Surgery. 100% of the Acute_adult_days are processed under the Surgery rate category, since cardiac surgery is a surgical category. 90% of the Critical_adult_days are processed under the CCU rate category, 7% under the TCU rate category, and 3% under the DOU rate category since the specific category is for a cardiac category. 75% of the Subacute_adult_days are processed under the SNF rate category and 25% under the Rehabilitation rate category. These distributions are then applied to the remaining six variables in a similar manner.

The nine variables provide utilization levels in terms of numbers of days. Accordingly, any Per diem payment mechanisms can be based upon this data. On the other hand, any Discount payment mechanisms require billed amounts. Billed amounts corresponding to each “days” variable can be estimated by multiplying Category_billed for the specific category by the ratio of the “days” variable to “Category_days.” For example, the billed amount attributable to Critical_adult_days, which can be referred to as Critical_adult_billed, can be estimated as follows:

$$Critical\_adult \_billed = Category\_billed \times \frac{Critical\_adult \_days}{Category\_days} .$$

Based upon the provided level of utilization in terms of days or billed amounts, the amount paid under the “level of care” rate mechanisms are determined for the specific category.

In the illustrative embodiment, if any data is processed under the “level of care” rates, using Table 10, the “level of care” rate categories to which data is mapped preferably have either Per diem or Discount base rates. This is the case since if a Per case rate is to be applied, the Per case rate can be applied as a base rate in the step 1008.

The method 1000 is preferably performed for all specific categories and all of the paid amounts calculated for the specific categories are accumulated in a “Total Paid” variable. After all of the specific categories have been processed, the “Total Paid” variable, which holds the total amount predicted to be paid under the subject rate plan, is provided as the result.

In accordance with an alternative embodiment, a standardized rate category can be broken into subcategories by levels of care so that a different rate structure is specified for each subcategory. A rate structure can be specified for each level of care to account for different levels of care within a standardized category.

V. Conclusion

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow. In method claims, reference characters are used for convenience of description only, and do not indicate a particular order for performing a method. As used in the claims, the term “based upon” is intended to encompass situations in which a factor is taken into account directly and/or indirectly, and possibly in conjunction with other factors, in producing a result or effect.

[image]

[image]

[image]

[image]

[image]

[image]

[image]

[image]

[image]

[image]

[image]

[image]

[image]

[image]

What is claimed is:

1. A method of determining a financial outcome under a provider-payer healthcare services agreement, the method comprising:
providing a first set of generally classified healthcare service utilization data;
providing a first set of specifically categorized healthcare service utilization data;
creating a second set of generally classified healthcare service utilization data based at least upon the first set of specifically categorized healthcare service utilization data;
creating a third set of generally classified healthcare service utilization data;
scaling the first set of specifically categorized healthcare service utilization data based at least upon the third set of generally classified healthcare service utilization data to produce a second set of specifically categorized healthcare service utilization data; and
applying a rate schedule to the second set of specifically categorized healthcare service utilization data to determine a financial outcome.

2. The method of claim 1, wherein the first set of generally classified healthcare service utilization data is representative of utilization levels of a subject service provider for which the financial outcome is determined.

3. The method of claim 1, wherein the first set of generally classified healthcare service utilization data is classified based upon greater than one and fewer than 10 classes of service.

4. The method of claim 1, wherein the first set of generally classified healthcare service utilization data comprises a total billed amount for each class of service.

5. The method of claim 1, wherein the first set of generally classified healthcare service utilization data comprises a total number of cases for each class of service.

6. The method of claim 1, wherein the first set of generally classified healthcare service utilization data comprises a total number of days for each class of service.

7. The method of claim 1, wherein the first set of specifically categorized healthcare service utilization data is based upon data collected by a governmental entity.

8. The method of claim 1, wherein the first set of specifically categorized healthcare service utilization data is categorized based at least upon Diagnostic Related Groupings.

9. The method of claim 1, further comprising adjusting the first set of specifically categorized healthcare service utilization data to account for inflation in utilization levels between a time when the first set of specifically categorized healthcare service utilization data is collected and a subject time period for which the financial outcome is determined.

10. The method of claim 1, wherein “creating a third set of generally classified healthcare service utilization data based at least upon the first set of generally classified healthcare service utilization data and the second set of generally classified healthcare service utilization data” comprises:
determining a first distribution of healthcare service utilization data among a plurality of classes of service based at least upon the first set of generally classified healthcare service utilization data;
determining a second distribution of healthcare service utilization data among a plurality of classes of service based at least upon the second set of generally classified healthcare service utilization data;
providing a first set of total levels of utilization; and
creating the third set of generally classified healthcare service utilization data based at least upon the first distribution, the second distribution, and the set of total levels of utilization.

11. A method of determining a financial outcome under a provider-payer healthcare services agreement, the method comprising:
providing a first set of healthcare service utilization data;
providing a second set of healthcare service utilization data;
scaling the second set of healthcare service utilization data based at least upon the first set of service utilization data to produce a third set of service utilization data; and
applying a rate schedule to the third set of healthcare service utilization data to determine a financial outcome.

12. The method of claim 11, wherein the first set of healthcare service utilization data is representative of utilization levels of a subject service provider for which the financial outcome is determined.

13. The method of claim 11, wherein the second set of healthcare service utilization data is based upon data collected by a governmental entity.

14. The method of claim 11, wherein “providing a first set of healthcare service utilization data” comprises:
providing a first distribution of healthcare service utilization data among a plurality of classes of service;
providing a second distribution of healthcare service utilization data among the plurality of classes of service;
providing a first set of total levels of utilization; and
creating the first set of healthcare service utilization data based at least upon the first distribution, the second distribution, and the set of total levels of utilization.

15. The method of claim 14, wherein the first distribution is based at least upon utilization levels in a set of generally classified healthcare service utilization data.

16. The method of claim 14, wherein the second distribution is based at least upon utilization levels in the second set of healthcare service utilization data.

17. The method of claim 11, wherein the first set comprises total levels of utilization.

18. The method of claim 11, wherein the first set comprises levels of utilization for a plurality of general classes of healthcare services.

19. A method of determining a financial outcome under a provider-payer healthcare services agreement, the method comprising:
creating a set of aggregate healthcare service utilization data based at least upon encounter-level data obtained from a governmental entity;
scaling the set of aggregate healthcare service utilization data to obtain a set of predictive healthcare service utilization data; and
applying a rate schedule to the set of predictive healthcare service utilization data to determine a financial outcome.

20. The method of claim 19, wherein the rate schedule specifies rates based upon DRGs and based upon levels of care.
